(19) United States
(12) Patent Application Publication
(10) Pub. No.: US 2020/0302515 A1
(43) Pub. Date: Sep. 24, 2020

(54) AUCTION METHOD

(71) Applicant: PLAY MY AUCTIONS INC., Komoka (CA)

(72) Inventors: KELLY JOHN CHANDLER, Komoka, Ontario (CA); JENNIFER LEE JACKSON, Komoka, Ontario (CA)

(21) Appl. No.: 16/754,803

(22) PCT Filed: Oct. 19, 2018
(86) PCT No.: PCT/CA2018/000199

§ 371 Date: Apr. 9, 2020

Related U.S. Application Data
(60) Provisional application No. 62/574,916, filed on Oct. 20, 2017.
(60) Provisional application No. 62/612,743, filed on Jan. 2, 2018.

(51) Int. Cl. G06Q 30/08; G06Q 30/06; G06Q 30/00; G06F 16/23

(52) U.S. Cl. CPC G06Q 30/08; G06F 16/2379; G06Q 30/0185; G06Q 30/0623

(57) ABSTRACT

An auction method for holding an auction in connection with a live event, for selling auction items connected with the live event, by commencing the auction before or during the live event, displaying information regarding the auction items to one or more auction participants, receiving bids from the auction participants, selecting a winning bid, and transferring the auction items to the winning bidder.

### FIELD OF THE INVENTION

The present invention relates to methods for conducting auctions, in particular, to methods for conducting an auction in association with a live event.

### BACKGROUND

Auctions are well known methods of selling goods or services, based on offering the goods or services, accepting bids, and selecting a winning bidder. One common type of auction is an open ascending auction, in which the auction participants bid against one another by submitting progressively higher bids, until there are no auction participants willing to submit a bid higher than the last. For many years, auctions have commonly been used to sell goods such as antiques, works of art, rare collectibles, and livestock. More recently, online auctions have increased the popularity of selling goods, such as electronics or other household or consumer items by way of auction.

Because of the competitive nature of most types of auctions, it is advantageous for sellers to maximize the number of potential bidders in an auction. Interest and participation in an auction is generally driven by demand for the goods or services being sold at the auction. For example, the demand for sports memorabilia is primarily found among sports fans, who regularly attend or view live sporting events. Participation in the auction by these sports fans requires that they be aware of the time and place of the auction and that they remain interested in purchasing sports memorabilia between the time of the live sporting event and the time of the auction.

Accordingly, there is a need for auction methods that take advantage of the level of interest of attendees or viewers of a live event in participating in an auction to purchase goods or services connected with the live event.

### SUMMARY OF THE INVENTION

An auction method, according to the present invention, comprises the steps of: commencing an auction with one or more auction participants before or during a live event; selecting one or more auction items connected with the live event; storing information regarding the one or more auction items on one or more auction servers; retrieving and displaying the information regarding the one or more auction items to the one or more auction participants using an electronic device configured to communicate with the one or more auction servers; receiving one or more bids on the one or more auction items from one or more auction participants; selecting a winning bid for the one or more auction items; and transferring the one or more auction items to the auction participant with the winning bid for each of the one or more auction items.

In another embodiment, the live event is a sporting event, an entertainment event, a musical performance, an artistic performance, an athletic performance, a business event, a political event, a religious event, a natural event, a cosmic event, or a scientific event.

In another embodiment, the one or more auction items are created as a result of their involvement in the live event.

In another embodiment, the live event is a live sporting event and the one or more auction items comprise sporting equipment used by one or more players during the live sporting event.

In another embodiment, the one or more auction items comprise one or more intangible items. The intangible items may be digital tokens, digital cards, digital certificates, digital representations, or virtualizations connected with the live event.

In another embodiment, at least one of the one or more intangible items is created at a time when a corresponding tangible item does not exist, and wherein the corresponding tangible item may exist at a later time.

In another embodiment, the one or more auction items are identified and recorded in a blockchain.

In another embodiment, at least one of the one or more auction items is marked with a machine readable code that includes a unique identification number which is recorded in a blockchain to facilitate verification of the authenticity of the auction item.

### BRIEF DESCRIPTION OF THE DRAWINGS

In order that the invention may be more clearly understood, embodiments thereof will now be described in detail by way of example, with reference to the accompanying drawings, in which:

FIG. 1 is a flow chart illustrating the steps of an auction method, according to the present invention.

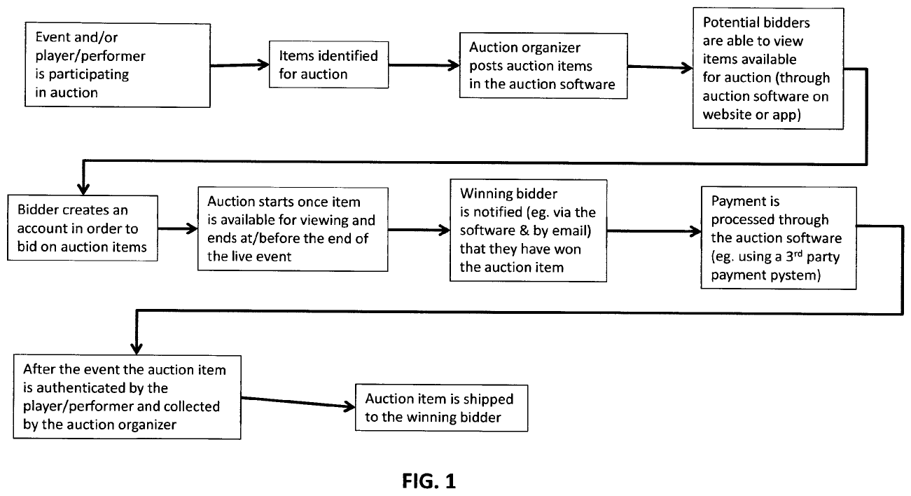

### DESCRIPTION OF THE INVENTION

The auction method, according to the present invention, facilitates the auctioning of items associated with a live event prior to or during the time the live event is taking place.

The method may be performed as any type of auction, such as an open ascending price auction. Other types of auctions or combinations of two or more different types of auctions may be used, such as a buyout auction, an absolute auction, a Dutch auction, a first-price sealed bid auction, a Vickrey auction, or a bidding fee auction. The auction may be open to the public or participation may be restricted. Where participation in the auction is restricted, participants may be required to sign up in order to view auction items or place bids. Alternatively, select auction participants may receive invitations to view items and place bids.

Optionally, one or more auction items may be selected for use in a draw held in connection with the auction. Auction participants, or other individuals who may not be able to or interested in placing bids, may be able to view the auction items in the draw the same way as for other auction items. The individuals may enter their name into the draw for the selected auction items in the draw. The draw is concluded at the same time as the auction, the winner of the draw is notified, and the item is delivered in the same way as for other auction items.

The method is preferably performed electronically, with participants using electronic devices to view items and place bids. Mobile electronic devices, such as smart phones, tablets, and laptop computers are preferably used to view items and place bids. Other types of mobile or non-mobile electronic devices may be used, including desktop computers or special purpose electronic devices configures specifically for use in the present method. The electronic devices communicate with one or more auction servers to view auction items and place bids. Preferably, the communication takes place via the Internet. Alternatively, the electronic devices may communicate with the one or more auction servers over a local area network, either wired or wireless. The present method will be described herein with reference to communication via the Internet, however, other suitable communications networks may be used.

The one or more auction servers may be server computers connected to the Internet and running an auction software application configured to store, retrieve, and transmit information about the auction items and to receive, store, and, if necessary, transmit information about the bids. The auction servers may be accessible via a website interface, or via another suitable interface, such as a software application for use on smartphones or other electronic devices. The auction servers may also be accessible via a plurality of interfaces to provide auction participants with a variety of ways to view information about the auction items and place bids. Accordingly, auction participants may or may not be physically present at the live event while participating in the auction.

The auction method is performed in association with a live event. Preferably the live event is a live sporting event or a live entertainment event. However, any type of live event may be suitable, such as a live musical, artistic, or athletic performance; a significant social, business, political, or religious event; or the occurrence of a natural, cosmic, or scientific event. The types of live events that are suitable for the present method involve the use of, produce, or result in goods, articles, or other things which are connected with the live event and susceptible for use as auction items. For example, the live event may be a golf tournament, such as the U.S. Open or the Masters professional tournaments; a professional or amateur sports game, such as a Major League Baseball or National Hockey League game, a National Collegiate Athletics Association game or tournament, the Tour de France, or one or more events involved in the Summer or Winter Olympic Games; a popular musician's concert or tour; an awards ceremony, such as the Oscars; or a political event, such as an election campaign.

A live event may be a single, one-off event or it may consist of a plurality of distinct, but related events or stages. For example, each game or round of an elimination-style tournament, common in the playoffs in professional sports leagues, may be treated as a separate live event or as parts of or stages in a single live event. Many events are set up as a series of stages, such as the Tour de France, while others are a single event, such as the Super Bowl.

The auction items selected for use with the present method are one or more goods, articles, or other things which are used in, produced by, result from, or are otherwise connected with the live event. The nature of the items will depend on the nature of the live event. For example, where the live event is a sporting event, such as a golf tournament, the auction items may include golf balls, golf clubs, or other sporting equipment used by the players during the event. For other types of sporting events, sports equipment, such as balls, pucks, bats, sticks, helmets, jerseys, gloves, bicycles, boards, or other sport-specific equipment or items may be used as auction items. Where the live event is a musical performance, the auction items may include instruments, amplifiers, costumes, stage props, or other musical equipment used by the performers in the musical performance.

Certain auction items, such as a game ball, for example, may not exist at the time the auction is commenced. Such items will be produced or created as a result of their use or involvement in the sporting event or other live event. What sets the game ball apart from other identical balls is its use in the sporting event. Although the game ball may not exist at the time the auction is commenced, the game ball may, nonetheless, be selected and listed as an auction item because there will be a game ball, even if its identity is unknown at the commencement of the auction. Similarly, a microphone or musical instrument used by a musician during a musical performance may be added as an auction item prior to its use in the particular performance.

Optionally, in addition to or in place of tangible goods, articles, or other things, as described above, the auction items used in the present method may intangible items which are connected with the live event. The intangible items may include digital tokens, card, certificates, representations, or virtualizations of any of the tangible auction items, as described herein, or of any of the players, participants, performers, spectators, or other people involved in the event. Alternatively, the intangible items may be digital tokens, cards, certificates, representations, or virtualizations of significant occurrences that take place during the live event, such as a game-winning goal in a sporting event. An intangible item may be created at any time prior to the end of the auction. Any kind of intangible item may be used as an auction item, whether recorded in digital media or other media, so long as the intangible item has some connection with the live event.

Due to the nature of intangible items, digital tokens, cards, certificates, representations, or virtualizations may be created in any desired number of substantially identical copies and are not limited by the existence or number of tangible items connected with the live event. For example, in connection with a sporting event, a single unique digital token may be created as a digital representation, or virtualization, of the jersey of a particular player, competing in the sporting event. This kind of digital token that represents a tangible item is sometimes referred to as a “tokenized” item, for example, a tokenized jersey. In another example, a fixed or unlimited number of substantially identical digital cards may be created with an image of a player along with descriptive text, similar to physical sports trading cards. Such cards may be created in a group of cards marked with a unique number, such as “1 of 50”, “2 of 50”, etc., but are otherwise identical, similar to traditional “limited edition” collector's cards.

Intangible items may also be created at a time when the corresponding tangible item or occurrence may or may not exist or occur at some later time in the future. For example, a digital token may be created and used as an auction item of a “hat trick” by a particular hockey player during a live sporting event, even though that player may or may not score three goals during the course of the game. Auction participants may bid on the tokenized occurrence and the winning bidder will receive the corresponding digital token, if the occurrence takes place. Alternatively, a limited or unlimited number of digital tokens may be created for the occurrence and auction participants may pay a set amount for the chance to receive one of the tokens, if the occurrence takes place. If the occurrence does not take place, then the auction participants may lose the amount paid, or may receive all or a portion of the amount back.

The intangible items may be viewable on any electronic device, such as a smart phone, capable of producing visual output, for example, on a screen. The intangible items may be viewed using a software application, running on the digital device, that permits the intangible item to be viewed in a number of ways, such as from a variety of angles, as a still image, as a series of images or a video, as a three-dimensional model, or any combination thereof. The intangible items may be arranged in a list, gallery, or digital space that may be customizable to permit the viewer to arrange the intangible items to their liking.

The images, video, text, and other content for intangible items may be created by the auction organizers or may be supplied by other content creators, including auction participants, individuals attending or participating in the live event, or professional photographers, videographers, graphic designers, and writers. Optionally, to incentivize the creation of content for intangible items for use as auction items, these content creators may receive a portion of the amount paid by the winning bidder for the auction items they create or contribute to.

The intangible items may be stored on any computer-readable medium, such as in the memory or storage of one or more auction servers or directly on the electronic device of the auction participant. Preferably, when a unique or fixed number of substantially identical intangible items are created, they are identified and logged in a blockchain. The same blockchain technology may also be used to log any transfer of the intangible items. For example, when the intangible item is transferred to the electronic device of a winning bidder, the transfer may be recorded in a blockchain. A blockchain is a list of records, called blocks, which are stored on a decentralized network of computers. The blocks are linked in a series or “blockchain” and secured using cryptography. The block is transmitted to the blockchain network, where it is stored and may be inspected for verification. The block may be a genesis block or it may be added to an existing blockchain. The block may be encrypted using any hash function algorithm, for example, the SHA256 algorithm.

Auction items may be added at any time between the commencement of the auction and the completion of the live event. For example, if a particularly significant event takes place during a live event, for example, a grand slam home run in a baseball game, the associated items (i.e. the baseball bat and/or the baseball) may be added to the auction as auction items, during the live event. The decision to add auction items to an auction during a live event may be made by the auction organizers or it may be made on request by the auction participants. The auction participants may use their electronic devices to transmit a request that a particular good, article, or other thing used in or otherwise connected with the live event, be added as an auction item.

An auction, according to the present method, may commence at any time prior to the completion of the live event. Preferably, the auction commences as soon as the live event is set to take place or is scheduled. Live events, such as professional sports games or major tournaments are typically scheduled well in advance, so the auction may begin any time thereafter. Other live events repeatedly take place at regular intervals, such as the Summer and Winter Olympic Games, and an auction may be commenced for a future round of the Olympic Games, despite the particular dates or locations being undetermined. Preferably, money transfer occurs at the time, or after, the auction ends, since certain auction items may result from future events that may or may not take place. For example, the jersey of a particular player in a sporting event may be listed as an auction item before the sporting event takes place. The player may not compete in the sporting event, due to injury or some other intervening event, and therefore the auction item would no longer be available.

In an exemplary embodiment of the auction method, according to the present invention, an on-line, worldwide, real-time auction is conducted during a live event. Auction participants use mobile electronic devices running a software application to communicate with computer servers, configured to transmit and receive information relating to the auction items and bids, and thereby view auction items and place bids. The auction items are one or more goods, articles, or other things used in or otherwise connected with the live event. At or before the completion of the live event, the auction ends and the winning bidder is selected from the auction participants who bid on each auction item and the auction item is transferred to the winning bidder once payment of the bid amount is received.

Verification of the authenticity of auction items may be provided for items that may be easily replicated or are otherwise indistinguishable from other similar items, such as a game ball in a sporting event. The verification is preferably conducted by auction organizers who are in attendance at the live event. Once an auction item is no longer needed for the live event, an auction organizer immediately takes possession of the auction item and marks it with a unique code or other identifying marking. Where the auction item is associated with a particular player, performer, or other participant in the live event, that individual may sign, or otherwise mark, the auction item personally.

The code or marking placed on the auction item by an auction organizer is preferably temporary and removable. Preferably, the code or marking is a machine readable code generated by the auction software application, such as a Quick Response code printed on a sticker that may be removably placed on the auction item. The code or marking includes a unique identification number that is transmitted to the auction participant with the winning bid for verification against the code or marking on the item itself. The auction participant may also be provided with a summary of their winning auction items with information on each item, including the name and date of the live event and/or the player, performer, or other participant in the live event with which the auction item is associated. This information may be in the form of a certificate of authenticity. In this way, the auction participant, who may not be physically present at the live event, can be provided with some assurance that the auction item they purchased is, in fact, connected with the live event.

Optionally, verification of the authenticity of auction items may be provided by way of blockchain technology. Preferably, when the winning bidder is selected for an auction item, identifying information is encrypted in a block, including: the unique code; the date, and/or time of the live event, auction, or winning bid; the name or other identifying information of the live event; the name or other identifying information of the winning bidder; the winning bid amount; or identifying information of one or more performers, athletes, or other participants in the live event. In this way, anyone seeking to purchase the auction item can verify, from the blockchain, that the person claiming to offer the auction item for sale is the winning bidder, or a successor in title. Transactions concerning the auction item may be encrypted into a subsequent block and added to the blockchain to track the ownership of the auction item to subsequent owners for future verification.

The present invention has been described with reference to an exemplary embodiment, however, it will be understood by those skilled in the art that various changed may be made and equivalents may be substituted for elements thereof without departing from the scope of the invention as set out in the following claims. Therefore, it is intended that the invention not be limited to the particular embodiments disclosed herein.

What is claimed is:

1. An auction method, comprising the steps of:
commencing an auction with one or more auction participants before or during a live event;
selecting one or more auction items connected with the live event;
storing information regarding the one or more auction items on one or more auction servers;
retrieving and displaying the information regarding the one or more auction items to the one or more auction participants using an electronic device configured to communicate with the one or more auction servers;
receiving one or more bids on the one or more auction items from one or more auction participants;
selecting a winning bid for the one or more auction items; and
transferring the one or more auction items to the auction participant with the winning bid for each of the one or more auction items.

2. The auction method of claim 1, wherein the auction comprises at least one type of auction selected from the group consisting of: an open ascending price auction, a buyout auction, an absolute auction, a Dutch auction, a first-price sealed bid auction, a Vickrey auction, and a bidding fee auction.

3. The auction method of claim 2, wherein the auction is a combination of two or more types of auctions.

4. The auction method of claim 2, wherein the auction further comprises a draw.

5. The auction method of claim 1, wherein the live event is a type of live event selected from the group consisting of: a sporting event, an entertainment event, a musical performance, an artistic performance, an athletic performance, a social event, a business event, a political event, a religious event, a natural event, a cosmic event, and a scientific event.

6. The auction method of claim 5, wherein the live event is a sporting event.

7. The auction method of claim 6, wherein the sporting event is a professional sports game.

8. The auction method of claim 5, wherein the live event is a musical performance.

9. The auction method of claim 1, wherein the live event is a single event.

10. The auction method of claim 1, wherein the live event consists of a plurality of related events.

11. The auction method of claim 6, wherein the one or more auction items comprise sporting equipment used by one or more players during the sporting event.

12. The auction method of claim 8, wherein the musical performance comprises one or more performers, and wherein the one or more auction items comprise musical equipment used by the one or more performers during the musical event.

13. The auction method of claim 1, wherein the one or more auction items are created as a result of their involvement in the live event.

14. The auction method of claim 1, wherein the auction items comprise one or more intangible items.

15. The auction method of claim 14, wherein the one or more intangible items are selected from the group consisting of: digital tokens, digital cards, digital certificates, digital representations, and virtualizations connected with the live event.

16. The auction method of claim 15, wherein the one or more intangible items comprise a plurality of substantially identical intangible items.

17. The auction method of claim 15, wherein at least one of the one or more intangible items is created at a time when a corresponding tangible item does not exist, and wherein the corresponding tangible item may exist at a later time.

18. The auction method of claim 15, wherein at least one of the one or more intangible items is created at a time when a corresponding occurrence has not taken place, and wherein the corresponding occurrence may take place at a later time.

19. The auction method of claim 1, wherein the one or more auction items are identified and recorded in a blockchain.

20. The auction method of claim 1, wherein the one or more auction items are selected at one or more times between the commencement of the auction and the completion of the live event.

21. The auction method of claim 1, wherein, the method further comprises the steps of: receiving a request from one or more of the auction participants for the selection of an auction item connected with the live event and selecting one or more auction items in response to the request.

22. The auction method of claim 1, further comprising the step of marking at least one of the one or more auction items with a unique marking.

23. The auction method of claim 22, wherein the unique marking comprises a machine readable code.

24. The auction method of claim 23, wherein the machine readable code comprises a unique identification number that is transmitted to the auction participant with the winning bid to facilitate verification of the authenticity of the auction item.

25. The auction method of claim 23, wherein the machine readable code comprises a unique identification number that is recorded in a blockchain to facilitate verification of the authenticity of the auction item.

26. The auction method of claim 25, wherein the transfer of the auction item to the auction participant with the winning bid is recorded in the blockchain.
